(19) United States
(12) Patent Application Publication
(10) Pub. No.: US 2005/0217157 A1
(43) Pub. Date: Oct. 6, 2005

(54) Orientation device for a sheet holder for material for a lifting and handling apparatus

(75) Inventors: Christophe Valette, Saint Bonnet de Cray (FR); Jean-Marc Bailly, Ambierle (FR)

Correspondence Address: HESLIN ROTHENBERG FARLEY & MESITI PC, 5 COLUMBIA CIRCLE, ALBANY, NY, 12203, US

(73) Assignee: Roger Mondelin S.A., Ambierle (FR)

(21) Appl. No.: 10/996,829

(22) Filed: Nov. 24, 2004

(30) Foreign Application Priority Data
Nov. 26, 2003 (FR) 0314096

(51) Int. Cl. G09F 3/20

(52) U.S. Cl. 40/650

(57) ABSTRACT

An orientation device for a holder of a sheet material or for a holder of a panel of material, for a lifting and handling apparatus, of the type comprising an upper end of an upright of the apparatus receiving a horizontal fixed support profiled section for the framework of the sheet holder or panel holder, the framework being mounted so as to be articulated relative to said support profiled section, is noteworthy in that the horizontal fixed support profiled section is offset relative to the upright and receives, at its end, an articulation rod of a sheet- or panel-support device. The latter device comprises a support base with a planar upper wall serving as support and fastening to the framework, and extending via two plates that are parallel and perpendicular to the planar upper wall. The plates are arranged with two curved, oblong apertures, allowing the passage of an indexing and locking means. The support base is able to rock from a position on the horizontal, while being locked, to a position on the vertical. An oblique intermediate position corresponds to loading of the panel or sheet holder or to deposition on an inclined surface.

The invention relates to the technical sector of lifting and handling apparatuses that can be used in the construction industry for presenting sheets of all types of material in order to form, for example, false ceilings.

The applicant has over a number of years developed apparatuses of this type for raising sheets or panels made from plaster or other materials, of sizeable form, dimensions and weight, from a height accessible to the user, placed on the ground, up to a position close to the ceilings being covered, in order to form said suspended ceilings.

Apparatuses of this type have been designed and developed by the applicant and have been, for example, the subject of patents FR 2 758 150 and 2 780 428. These apparatuses comprise a rolling underframe (1) with an upright (2) consisting of telescopic elements maneuvered by a cable/pulley assembly reeved and actuated by a winch (3). The upper end of said upright is arranged to receive a material-holding or sheet-holding platform (4).

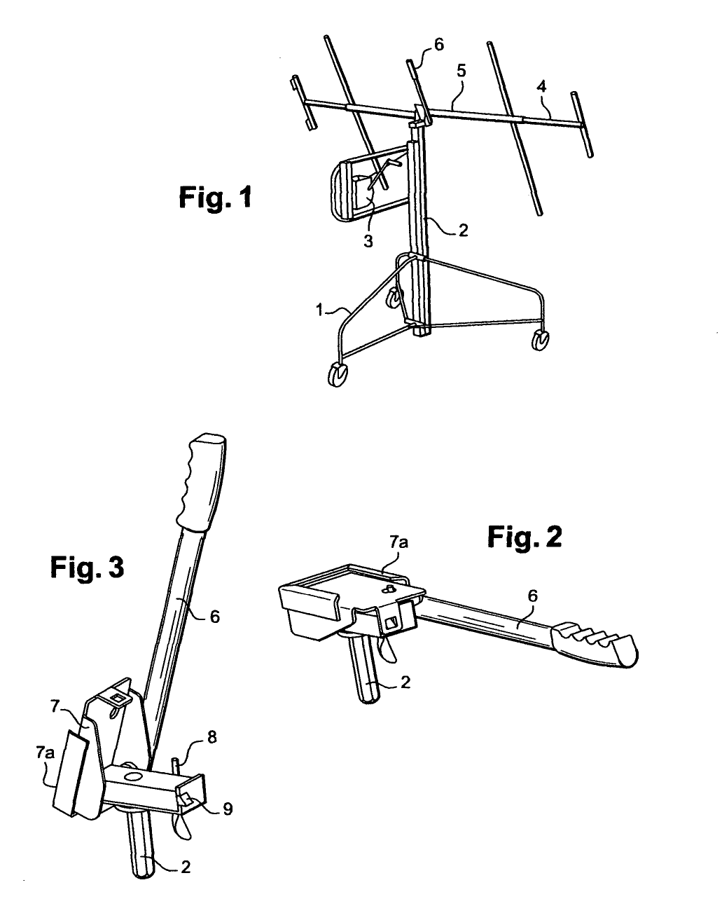

FIG. 1 shows a lifting apparatus of this type. In practice, the material-holding or sheet-holding platform is established and designed to be presented in an oblique position for receiving the panel and then articulated in order to assume a horizontal position for presenting the panel as a suspended ceiling.

FIGS. 2 and 3 show the device allowing articulation of the panel holder. The upper end part of the upright thus receives a fixed-position horizontal support bar (5) on which, with the aid of a maneuvering lever (6), a stirrup piece (7) is articulated, said stirrup piece (7) receiving, transversely, the support bar (7a) of the panel-support platform. Locking means (8-9) are provided for securing the stirrup piece (7) and the support base (5) in a horizontal position.

The problem posed in this particular version lies in the fact that the lifting and handling apparatus is quite unsuitable for allowing presentation of panels in a vertical position with a view to arranging said panels to form partitions and the like. In practice, said apparatuses are not designed to allow this additional function, and the version set out and illustrated in FIGS. 2 and 3 means that there would be problems of safety and apparatus stability.

The applicant's approach was thus to consider a novel arrangement of the articulation device of the panel holder or sheet holder relative to the upright, constructing a device able to allow and provide the above-mentioned novel function and to do so with complete safety.

A further object sought according to the invention was to design a device allowing the presentation of panels or sheets to be deposited in vertical, horizontal or oblique planes, with deposition on the apparatus in an oblique position, for loading, this being achieved within the context of simple implementation and requiring the operator to perform a single control maneuver.

These and yet further objects will become clearly apparent from the remainder of the description.

According to a first characteristic of the invention, the orientation device for a holder of a sheet material or for a holder of a panel of material, for a lifting and handling apparatus, of the type comprising an upper end of the upright of the apparatus receiving a support profile for the framework of the sheet holder or panel holder, said framework being mounted so as to be articulated relative to said support profiled section, is noteworthy in that said horizontal fixed support profiled section is offset relative to the upright part and receives, at the end, an articulation rod of the sheet- or panel-support device, the latter comprising a support base with a planar upper wall serving as support and fastening to the framework, and extending via two plates that are parallel and perpendicular to the planar base, said plates being arranged with two curved, oblong apertures, allowing the passage of an indexing and locking means, and in that the support base is able to rock from a position on the horizontal, while being locked, to a position on the vertical, the oblique intermediate position corresponding to loading of the panel or sheet holder or to deposition on an inclined surface.

These and yet further characteristics will become clearly apparent from the remainder of the description.

With a view to establishing the subject of the invention, it is illustrated in a non-limiting manner in the figures of the drawings, in which:

FIG. 1 is a perspective view of a panel- or sheet-lifting and handling apparatus according to the prior art of the applicant;

FIGS. 2 and 3 are large-scale partial views illustrating the articulation device of the panel holder according to the apparatus of FIG. 1, said views showing the device in the horizontal position and in the oblique position;

FIG. 4 is a perspective view, from the left, of the device according to the invention, with presentation of the panels in a horizontal position;

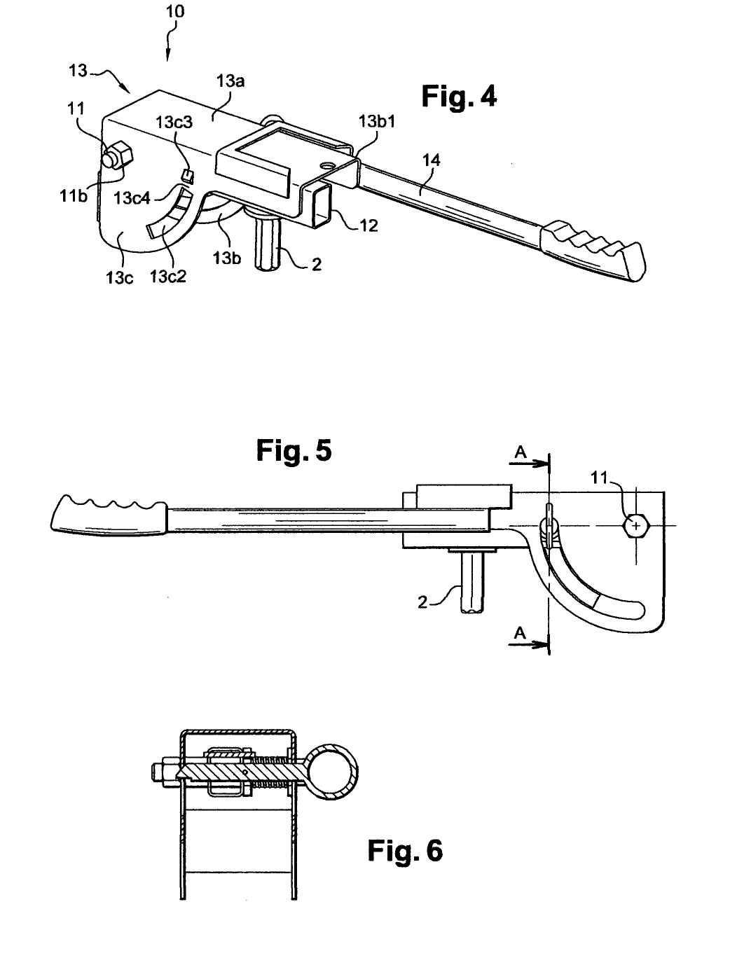

FIG. 5 is a right-side view of the device;

FIG. 6 is a sectional view, on line A-A of FIG. 5;

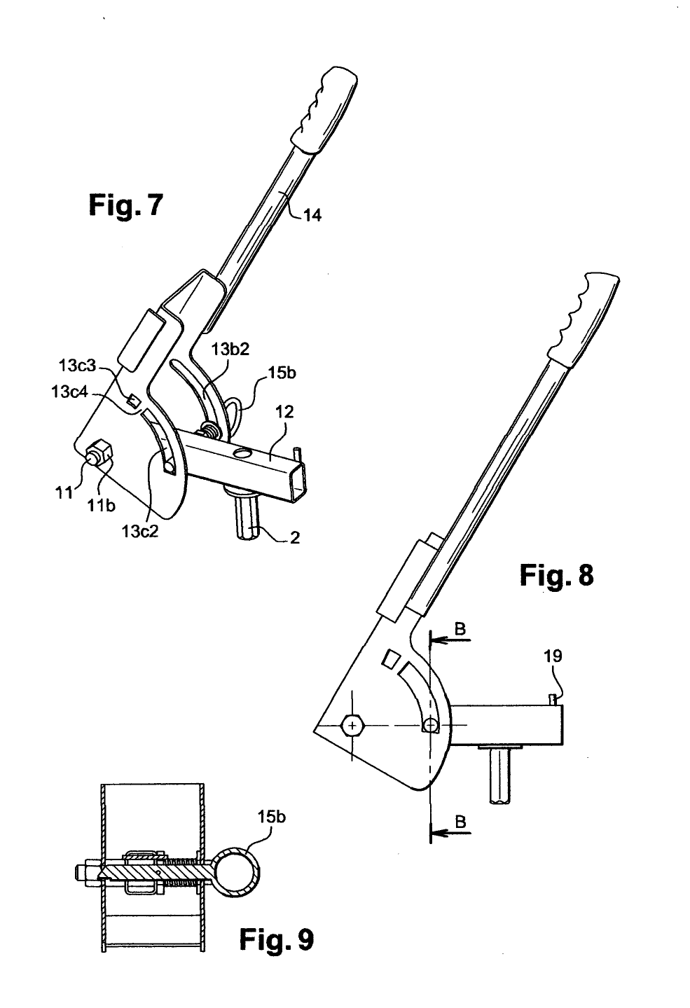

FIG. 7 is a perspective view of the device after raising part way;

FIG. 8 is a side view of the left side of the device, corresponding to FIG. 7;

FIG. 9 is a sectional view, on line B-B of FIG. 8;

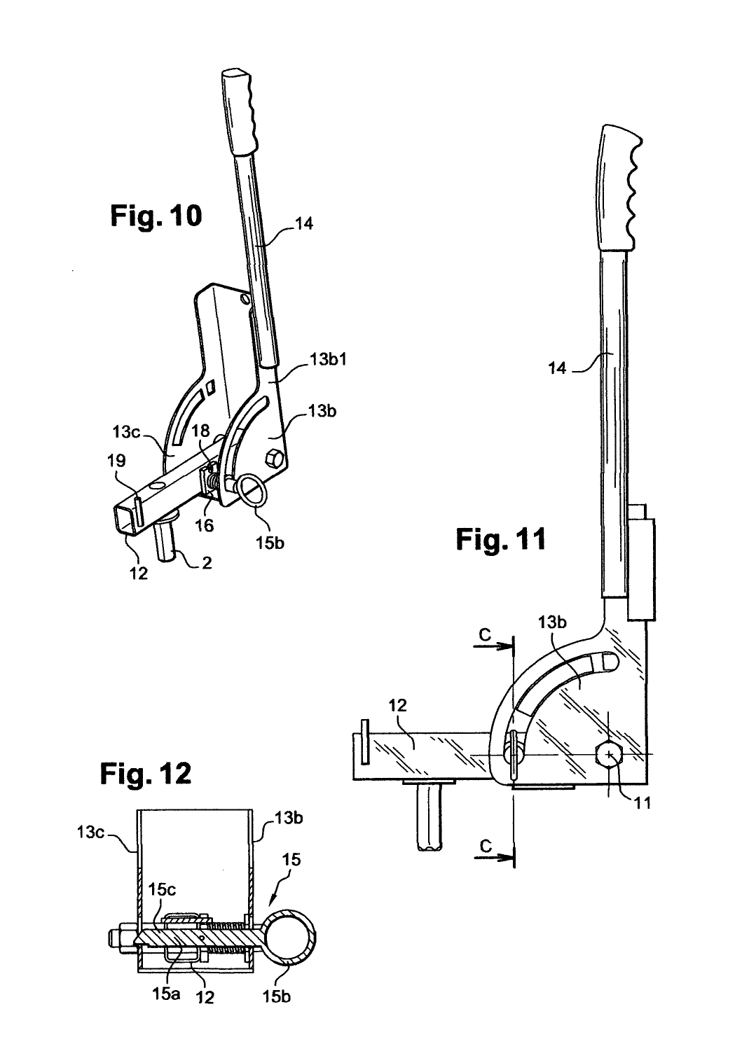

FIG. 10 is a perspective view of the device in the position of maximum raising to the vertical;

FIG. 11 is a side view of the device according to FIG. 10;

FIG. 12 is a sectional view, on line C-C of FIG. 11;

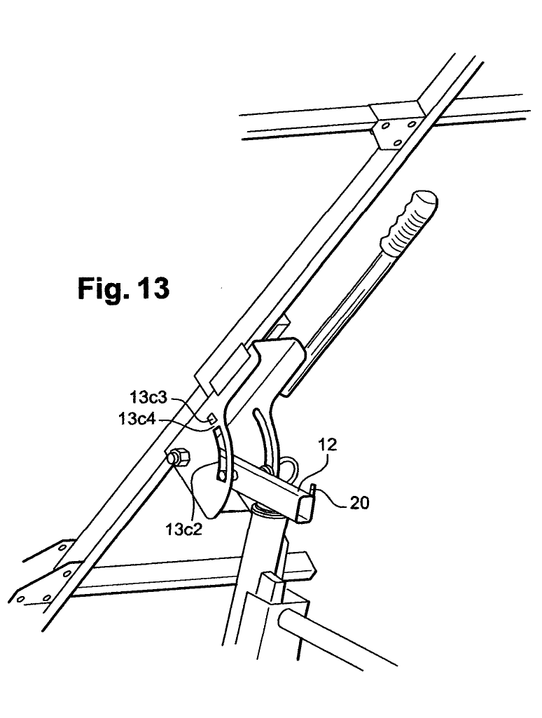

FIG. 13 is a large-scale, perspective view of the device according to the invention in an oblique raised position, seen from one side;

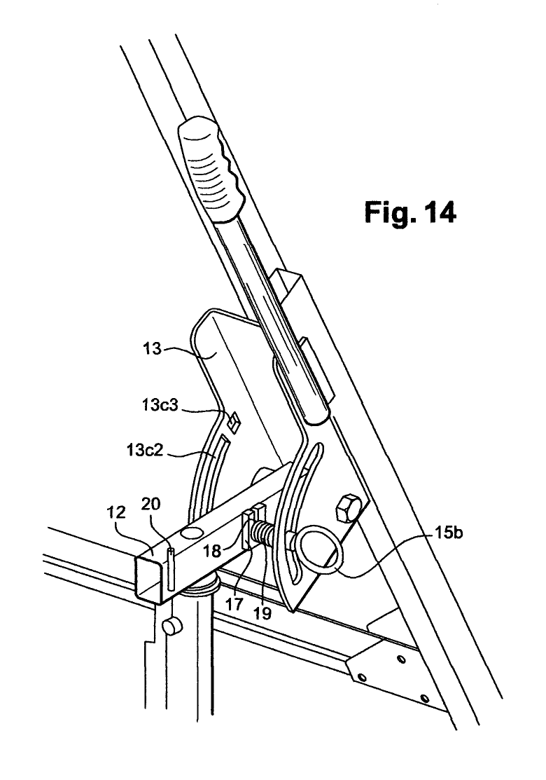

FIG. 14 is a view similar to that of FIG. 13, but viewed from the other side;

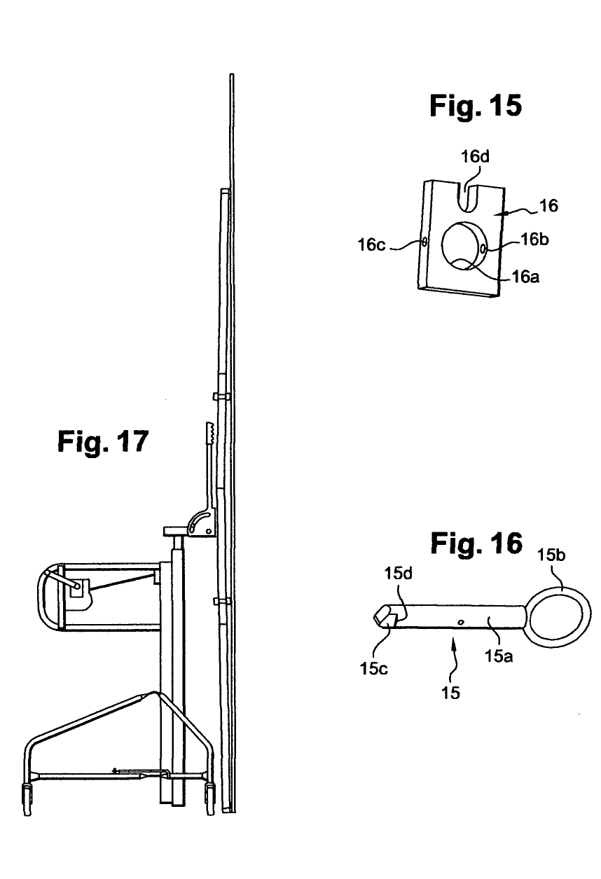

FIG. 15 is a view of a component known as the guide plate;

FIG. 16 is a view of a component, namely an indexing and locking finger;

FIG. 17 is a view of the apparatus according to the invention, taken overall; with presentation of a panel in the vertical position;

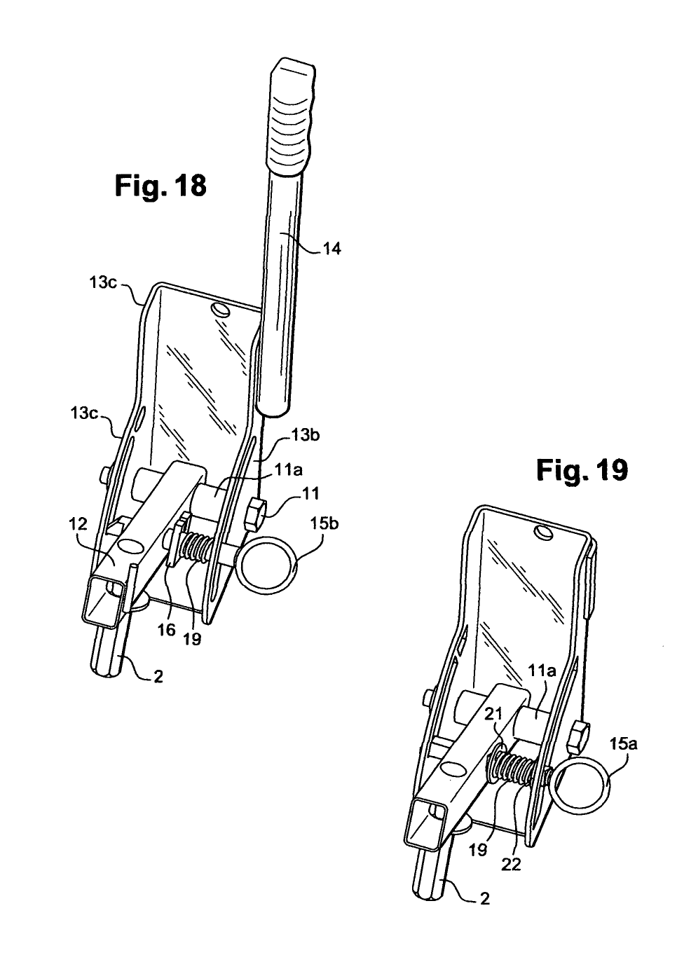

FIG. 18 is a substantially front view of the device of FIG. 10;

FIG. 19 is a variant, substantially front view showing, in particular, guiding of the indexing and locking means;

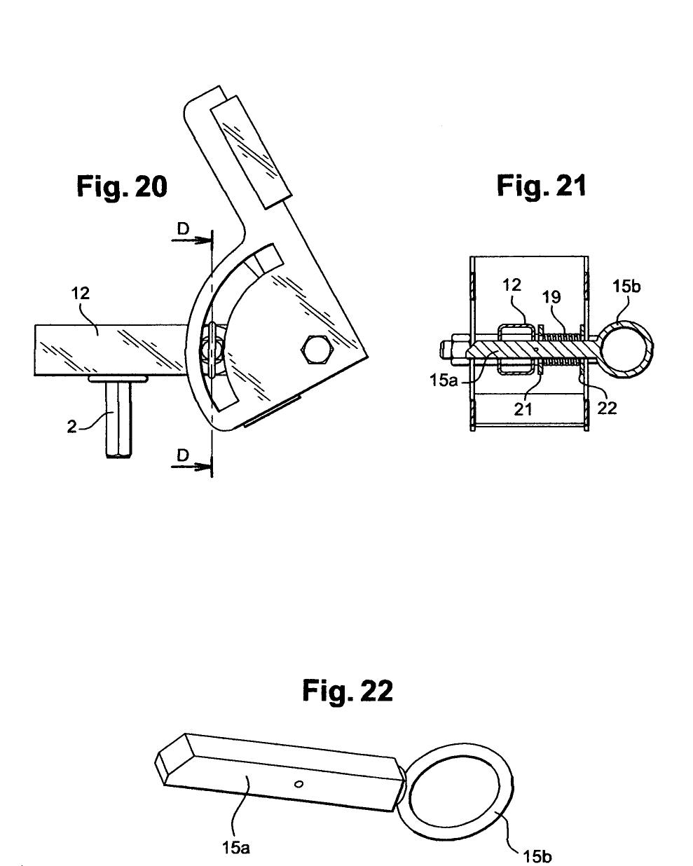

FIG. 20 is a side view of the device according to FIG. 19;

FIG. 21 is a sectional view, on line D-D of FIG. 20;

FIG. 22 is a view of the indexing and locking means used in a variant embodiment according to FIGS. 19 to 21.

In order to render the subject of the invention more concrete, it is now described in a non-limiting manner illustrated in the figures of the drawings.

The articulation device of the support for sheets or panels of material is referenced overall by (10). It may be fixed, with articulation, on a rod (11), relative to a horizontal fixed profiled section (12) forming a longitudinal member and itself secured to the upper end of the upright (2) of the apparatus. Said rod (11) is guided in a spacer (11a) (FIG. 18) established in the profiled section (12), and it receives a fastening and tightening nut (11b). The device comprises a support base (13) that has a wide planar upper wall (13a) serving as bearing position and position for fixing to the framework of the panel holder and/or sheet holder (14) known per se and not modified as compared to the prior art. Said support base (13) has two parallel side plates (13b-13c) perpendicular to the planar upper wall (13a) and surrounding the above-mentioned fixed profiled section (12) so as to constitute, to an extent, an articulation fork piece. One of the plates (13b) receives, in its upper part (13b1), in a fixed position, a maneuvering arm (14) controlling the articulation and the positioning of the device relative to the upright part (2) with regard to different horizontal, vertical or intermediate oblique positions. The horizontal profiled section (12) is fixed in such a manner that the essential part of its length is offset relative to the upright (2) and has a wide overhang to allow 90° pivoting of the panel holder or sheet holder, this being so that the underframe part of the apparatus does not interfere with the vertical position of the panel holder or sheet holder.

The device (10) according to the invention is arranged to receive safety and position-locking means allowing position-indexing and preventing any inappropriate maneuver.

According to the invention, the device is constructed in an optimized version with plates (13b-13c) each having a curved oblong aperture (13b2-13c2) allowing the passage and the fixed positioning in the horizontal plane of an indexing and locking means (15) passing right through the profiled section (12) and emerging on the above-mentioned two plates (13b-13c). The indexing and locking means (15) thus comprises a rod (15a) provided with a head (15b) in the form of a gripping ring. The end (15c) of the rod is beveled to define a support bearing surface (15d) that comes into contact with the inner face opposite the plate (13b). According to a particular arrangement, the rod (15a) is integral with a guide plate (16) shown in FIG. 14 by a pin (17), a screw or the like, such that the axial displacement of the rod through action on the ring is possible only by entraining the guide plate. The latter thus has an opening (16a) for passage of the rod (15a), two holes (16b-16c) for insertion of the link pin (17), and a U-slot (16d) allowing the insertion of a finger (18) arranged on the transverse bearing face of the profiled section (12) forming the longitudinal member. A return means (19) of the spring type is thus arranged on the rod (15a) between the guide plate and the opposite inner face of the plate (13b). It will therefore be understood that when a relaxation action is exerted on the spring the guide plate will be kept in contact with and bear against the profiled section (12), the means (15) not being urged. In this version, the rod (15a), via its end (15c), emerges in the oblong aperture (13c2) formed opposite on the plate (13c). The bearing part (15d) of the rod (15a) comes into contact with the inner face of said plate (13c). This position is established when the panel holder or sheet holder is in the oblique loading or transportation position.

In the case of the extreme positions that correspond to the positions of use of the panel holder or sheet holder, either in the horizontal plane or in the vertical plane, the applicant sought to achieve a version guaranteeing complete handling safety and preventing unexpected, inappropriate rocking of the panel holder or sheet holder.

To that end, the two oblong apertures (13b2-13c2) established in the plates of the support base are produced over a different angular sector on the one hand and are continuous or discontinuous on the other hand, as explained below. The oblong aperture (13b2) established in the plate (13b) is located on the side receiving the locking means with the ring and is established over an amplitude α1 of 90°, which corresponds to the rocking amplitude of the panel holder or sheet holder, and it is continuous. The oblong aperture (13c2) established in the other plate (13c) is established over a smaller angular sector having an amplitude α2 of the order of 65°, discontinuously. In other words, the aperture (13c2) is shorter than the aperture (13b2), but has the same width. Furthermore, said aperture (13c2) is not uniform, as it is discontinuous. It thus comprises an independent upper open part (13c3) forming a housing for the end of the rod (15a) in the horizontal position of the panel holder and then an intermediate solid part (13c4) separating it from the rest of the principal part (13c2), all this being over a curve in order to match the rocking movements. Thus, the opening (13c3) is completely delimited and constitutes a means for immobilizing and locking the rod (15a) and thus the panel holder or sheet holder in position. Only the exertion of a force (F) on the ring of the indexing and locking means (15) allows pivoting of the panel holder or sheet holder to be released by disengaging the end of the rod (15a) from the receiving opening (13c3).

In the case of the bottom part corresponding to the vertical position of the panel holder, it is possible to choose whether to incorporate the safety immobilizing function. If this function is established (situation not shown in the drawings), provision is made, in an identical manner to the horizontal-position-safety means, for a supplementary opening beyond the curved aperture (13c2), with identical implementation as in the previous case but at the other end of the aperture.

If, conversely, it is not necessary to have this additional safety feature for the vertical position, provision is made for said aperture (13c2) not to extend over the plate (13c) from the support base as a level corresponding to full rocking of the panel holder or sheet holder to the vertical position. In this case, the indexing and locking means (15) comes, via its end, to bear on the opposite inner face of said plate, thus being substantially disengaged, this being counter to the above-mentioned return spring.

Without departing from the scope of the invention, the indexing and locking means (15) may, as illustrated in FIG. 22, have a square-section rod (15a) while the profiled section (12) is arranged with an opening of corresponding cross section for the insertion of the rod. Two washers (21-22) are arranged on the rod (15a), one (21) being integral with the rod and coming to bear against the profiled section, and the other (22) being against the head, the return spring (19) of the type described above being located between said washers and on the rod. This version is simpler in structure.

Thus, the device of the invention is extremely practical to implement and offers, by means of a simple manual action on the indexing and locking means (15), every possibility to present the apparatus in the desired position for loading, namely vertical, horizontal or oblique.

According to a known arrangement, it should be noted that the profiled section (12) may have a projecting vertical finger (20) engaging in an opening (13f) formed in the upper planar face of the support base.

The advantages are clearly apparent from the invention. The simplicity of the device and the astute use of two oblong apertures of different characteristics is emphasized.

1. An orientation device for a holder of a sheet material or for a holder of a panel of material, for a lifting and handling apparatus, of the type comprising an upper end of the upright of the apparatus receiving a support profile for the framework of the sheet holder or panel holder, said framework being mounted so as to be articulated relative to said support profiled section, wherein said horizontal fixed support profiled section (12) is offset relative to the upright part and receives, at the end, an articulation rod (11) of the sheet- or panel-support device, the latter comprising a support base with a planar upper wall (13a) serving as support and fastening to the framework, and extending via two plates (13b), (13c) that are parallel and perpendicular to the planar base (13a), said plates being arranged with two curved, oblong apertures (13b2), (13c2), allowing the passage of an indexing and locking means (15),
and wherein the support base is able to rock from a position on the horizontal, while being locked, to a position on the vertical, the oblique intermediate position corresponding to loading of the panel or sheet holder or to deposition on an inclined surface.

2. The device as claimed in claim 1, wherein the indexing and locking means established in a horizontal plane and traversing the profiled section (12) comprises a rod (15a) provided with a head (15b) in the form of a gripping ring, the end of the rod (15a) being beveled (15c) and having a support bearing surface (15d).

3. The device as claimed in claim 2, wherein the rod (15a) is secured to a guide plate (16) that can bear and be positioned relative to the transverse bearing face of the profiled section (12),
and wherein a return means (19) is arranged on the rod (15a) between the guide plate and the inner face opposite the plate (13b), the displacement at the time of the pulling action of the ring part (15b) of the means (15) being effected against said elastic means (19).

4. The device as claimed in claim 3, wherein the guide plate (16) has an opening (16a) for passage of the rod (15a), two holes (16b)-(16c) for insertion of a link pin (17) and a U-slot (16d) allowing the insertion of a finger (18) arranged on the transverse bearing face of the profiled section (12).

5. The device as claimed in either of claims 1 and 2, wherein, in the loading and transportation position, the panel holder or sheet holder is in an oblique position and the rod (15a), via its end, traverses the aperture (13b2) of the plate (13b) and the aperture (13c2) of the plate (13c), the support bearing surface (15d) of the rod coming into contact with the inner face of said plate (13c).

6. The device as claimed in either of claims 1 and 2, wherein the two oblong apertures (13b2-13c2) made in the plates (13b-13c) are produced along an angular sector that is differentiated, on the one hand in accordance with the different amplitudes α1 and α2, continuously in the case of the aperture (13b2) and discontinuously in the case of the aperture (13c2).

7. The device as claimed in claim 6, wherein the oblong aperture (13b2) made in the plate (13b) is established in accordance with an amplitude α1 of 90° corresponding to the amplitude of rocking of the panel holder or sheet holder.

8. The device as claimed in claim 6, wherein the oblong aperture (13c2) is established according to an amplitude α2 of the order of 65°, being discontinuous, while comprising an independent upper open part (13c3) forming a housing of the end of the rod (15a) in the horizontal position of the panel holder or sheet holder, and then an intermediate solid part (13c4) separating it from the rest of the principal part (13c2),
and wherein the part (13c3) constitutes a means for immobilizing and locking the rod (15a) in position.

9. The device as claimed in claim 8, wherein, in the case of the bottom part corresponding to the vertical position of the panel holder incorporating the immobilizing and locking function, a supplementary opening identical to the opening (13c3) is arranged in the bottom part extending the aperture (13c2).

10. The device as claimed in claim 8, wherein, in the case of the bottom part corresponding to the vertical position and being incorporated for the immobilizing and locking function, the aperture (13c2) does not extend on the plate (13c) from the support base as far as a level corresponding to full rocking of the panel holder and sheet holder to the vertical, and the indexing and locking means (15) comes to bear, via its end, on the inner face opposite said plate.

11. The device as claimed in claim 3, wherein the indexing and locking means (15) has a square-section rod (15a), the profiled section (12) being arranged with corresponding openings,
and wherein two washers (21-22) are mounted on the rod, one (21) being integral with the rod and coming to bear against the profiled section and the other washer (22) being mounted on the same side as the head (15b) of said means (15),
and wherein a return spring (19) is inserted between said washers.
